(19) United States
(12) Patent Application Publication
(10) Pub. No.: US 2011/0071944 A1
(43) Pub. Date: Mar. 24, 2011

(54) SYSTEM AND METHOD FOR DISPENSING POSTAGE WITHOUT PRINTING

(75) Inventors: Richard W. Heiden, Huntington, CT (US); John W. Sussmeier, Cold Spring, NY (US)

(73) Assignee: Pitney Bowes Inc., Stamford, CT (US)

(21) Appl. No.: 12/564,098

(22) Filed: Sep. 22, 2009

(51) Int. Cl. G07B 17/02; G06Q 20/00; G06Q 50/00; G06F 17/00

(52) U.S. Cl. 705/41; 705/404; 235/375

(57) ABSTRACT

A method of dispensing evidence of postage payment that includes providing a machine readable mechanism, such as a barcode, for being associated with a mailpiece to a customer, wherein the machine readable mechanism includes a first identifier and the customer has a customer identifier. The method further includes receiving first information from a mobile electronic device associated with the customer, the first information including: (i) the first identifier, (ii) the customer identifier, and (iii) mailpiece information, preferably including a postage amount, relating to the mailpiece, the first identifier included in the first information having been obtained based on an image of the pre-printed machine readable mechanism captured by the mobile electronic device, deducting a postage amount based on the mailpiece information from a postage account associated with the customer identifier, and transmitting the first identifier and verification of payment for postage to a carrier.

### FIELD OF THE INVENTION

The present invention relates to the dispensing of postage for a mailpiece, and in particular, to a system and method for dispensing and providing postage for a mailpiece that does not require a printer to print evidence of postage payment.

### BACKGROUND OF THE INVENTION

Postage metering systems are well known in the art, and are often incorporated into mail processing systems, such as mailing machines. A typical postage meter applies evidence of postage, commonly referred to as postal indicia, to envelopes or other mailpieces and accounts for the value of the postage dispensed. As is well known, postage meters include an ascending register that stores a running total of all postage dispensed by the meter, and a descending register that holds the remaining amount of postage credited to the meter and that is reduced by the amount of postage dispensed during a transaction. The postage meter generally also includes a control sum register which provides a check upon the descending and ascending registers. The control sum register has a running account of the total funds being added into the meter. The control sum register must always correspond with the summed readings of the ascending and descending registers. The control sum register is the total amount of postage ever put into the machine and it is alterable only when adding funds to the meter. In this manner, by inspecting the various registers and securing them from tampering, the dispensing of postal funds may be accurately recorded, tracked and accounted for.

More recently, postage metering systems have been developed where the accounting structure described above is no longer resident with the user. Sometimes referred to as a “virtual postage meter,” these types of postage metering/printing systems dispense postage electronically over suitable communication channels (LAN, WAN, telephone lines, Internet, etc.). The user maintains an account with a remotely located data center (typically maintained by an authorized postage meter manufacturer) and receives postage in the form of a postal indicium securely using appropriate electronic data interchange techniques. At a later time, the user is invoiced for the amount of postage dispensed and any other fees associated with maintaining the account with the data center. Typically, a secret code or token is derived from information particular to the mailpiece (the indicated postage amount, date, recipient address information, etc.) and is incorporated or embedded into the postal indicium (e.g., in the form of an encrypted barcode) for later use by a postal authority in verifying the integrity of the postal indicium. Examples of such systems are described in U.S. Pat. No. 4,725,718 and U.S. Pat. No. 5,454,038.

In current virtual systems as just described, the received postal indicium must be printed on either the mailpiece itself or a label applied to the mailpiece. When a user is using a PC to dispense postage in this manner, such printing is not an issue as an appropriate printer is typically readily available. However, if the user wishes to use a mobile electronic device, such as a cell phone or personal digital assistant (PDA), to provide evidence of postage payment, printing an indicium may be an issue as an appropriate printer is often times not readily available.

Thus, there is a need for a system and method for dispensing and providing postage for a mailpiece that does not require a printer to be readily available to print evidence of postage payment.

### SUMMARY OF THE INVENTION

In one embodiment, the invention provides a method of dispensing evidence of postage payment that includes providing a machine readable mechanism, such as a pre-printed barcode, for being associated with a mailpiece to a customer, wherein the machine readable mechanism includes a first identifier and wherein the customer has a customer identifier. The method further includes receiving first information from a mobile electronic device associated with the customer, the first information including: (i) the first identifier, (ii) the customer identifier, and (iii) mailpiece information relating to the mailpiece, the first identifier included in the first information having been obtained from the machine readable mechanism captured by the mobile electronic device, deducting a postage amount based on the mailpiece information from a postage account associated with the customer identifier, and transmitting the first identifier and verification of payment for postage to a carrier. In one particular embodiment, the mailpiece information includes the postage amount. The mailpiece information may further include recipient address information, wherein the transmitting further comprises transmitting the recipient address information to the carrier.

The machine readable mechanism preferably comprises a pre-printed barcode (e.g., a 2-D barcode), and may be provided on a label structured to be affixed to a mailing device, such as an envelop or a box, of the mailpiece, or, alternatively, may be pre-printed on the mailing device itself. Alternatively, the machine readable mechanism comprises an RFID tag.

In another embodiment, the invention provides a method of providing evidence of postage payment for a mailpiece that includes obtaining information from a machine readable mechanism using a mobile electronic device associated with a customer, wherein the customer has a customer identifier and the machine readable mechanism includes a first identifier, obtaining the first identifier from the machine readable mechanism, and transmitting first information from the mobile electronic device to a provider maintaining a postage account for the customer, the first information including: (i) the first identifier, (ii) the customer identifier, and (iii) mailpiece information relating to the mailpiece. Preferably, the mailpiece information includes a postage amount for the mailpiece. The mailpiece information may further include recipient address information, wherein the transmitting further comprises transmitting the recipient address information to the carrier.

The method may further includes steps of obtaining the machine readable mechanism prior to the capturing, and physically associating the machine readable mechanism with the mailpiece and depositing the mailpiece with a carrier for delivery. In one specific embodiment, a barcode is provided on a label, and the physically associating step comprises affixing the label to a mailing device of the mailpiece. In another embodiment, a barcode is pre-printed on a mailing device to be used with the mailpiece, and the physically associating comprises inserting one or more items into the mailing device.

In addition, the invention also provides a mobile electronic device having a processor, a memory, and an information capturing device, wherein the memory has one or more routines executable by the processor, the one or more routines having instructions for causing the mobile electronic device to perform the method described above.

In another embodiment, the invention provides a postal software application for a mobile electronic device, wherein the mobile electronic device is associated with a customer having a customer identifier. The postal software application is stored on a computer readable medium and has a plurality of instructions for causing the mobile electronic device to obtain information from a machine readable mechanism using, for example, an electronic image capture device, the machine readable mechanism including a first identifier, the information obtained including the first identifier, and transmit first information from the mobile electronic device to a provider maintaining a postage account for the customer, the first information including: (i) the first identifier, (ii) the customer identifier, and (iii) mailpiece information relating to the mailpiece. Preferably, the mailpiece information includes a postage amount for the mailpiece. The mailpiece information may further include recipient address information, wherein the transmitting further comprises transmitting the recipient address information to the carrier.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of postage dispensing system according to one particular embodiment of the present invention;

FIG. 2 is a block diagram of an exemplary mobile electronic device that may be employed in the postage dispensing system of FIG. 1;

FIG. 3 is a flowchart showing a method of dispensing and providing postage using the postage dispensing system according to one particular embodiment of the invention from the perspective of a user of a mobile electronic device wishing to provide evidence of postage payment for a mailpiece; and

FIG. 4 is a flowchart showing the method of dispensing and providing postage of the present invention from the perspective of the provider data center of the system of FIG. 1.

### DESCRIPTION OF THE PREFERRED EMBODIMENTS

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As employed, herein, the statement that two or more parts or components are “coupled” together shall mean that the parts are joined or operate together either directly or through one or more intermediate parts or components. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

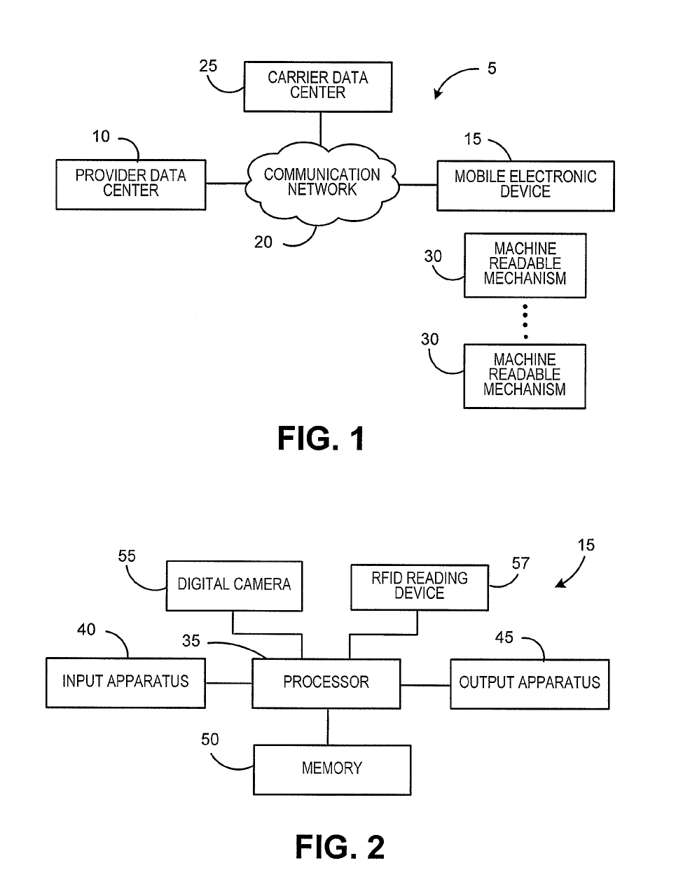

FIG. 1 is a block diagram of a postage dispensing system 5 according to one particular embodiment of the present invention. As described in greater detail below, the postage dispensing system 5 enables a user to receive and provide evidence of postage payment for a mailpiece without requiring a printer to print the evidence of postage payment at time the postage is dispensed (or thereafter). It should be understood that the postage dispensing system 5 is just one particular embodiment of a postage dispensing system in which the present invention may be implemented, and that the invention as described herein may also be implemented in other configurations and/or embodiments

The postage dispensing system 5 includes a provider data center 10 that includes a suitable processing system having a computing device such as a server computer and one or more memory components for data storage. The provider data center 10 is maintained and operated by a service provider such as an authorized postage meter manufacturer or some other agency or entity authorized to dispense postage. The provider data center 10 is in electronic communication with one or more remotely located mobile electronic devices 15 (only one mobile electronic device 15 is shown in FIG. 1 for purposes of clarity of description) over any suitable communication network 20 such as the Internet. Each mobile electronic device 15 may be, for example and without limitation, a personal data assistant (PDA), a handheld computer, a two-way pager, a cellular telephone, and the like. The postage dispensing system 5 also includes a carrier data center 25 that is operated by the postal carrier for which the provider data center 10 is authorized to dispense postage. The carrier data center 25 includes a suitable processing system having a computing device such as a server computer and one or more memory components for data storage. The carrier data center 25 is operatively coupled to the communication network 20 to enable electronic communication between the provider data center 10 and the carrier data center 25.

As seen in FIG. 1, the postage dispensing system 5 of the preferred embodiment contemplates the use of one or more machine readable mechanisms 30 that are provided to the user of the mobile electronic device 15 by the provider operating the provider data center 10. Each machine readable mechanism 30 includes a unique identifier, such as a unique identification number, that allows it to be uniquely identified by the provider. In the preferred embodiment described herein, the machine readable mechanisms 30 comprise pre-printed barcodes in the form of a two-dimensional barcode, such as a standard Datamatrix barcode, and are provided on a label that may be affixed to a mailpiece by the user for use as evidence of postage payment. Alternatively, each pre-printed barcode may be provided on a mailing device, such as an envelope or a box, into which an item to be mailed may be inserted. Also, the pre-printed barcodes may have other formats, such as a one dimensional barcode or another 2-D barcode format. Also, another type of pre-printed machine readable element may be substituted for the pre-printed barcodes within the scope of the present invention. In the case where the pre-printed barcode is provided on a mailing device, the barcode could also include information that identifies the specific mail piece type. In other embodiments, the machine readable mechanisms 30 can comprise Radio Frequency Identification (RFID) tags that include a unique identifier, such as a unique identification number, that allow each to be uniquely identified by the provider.

FIG. 2 is a block diagram of an exemplary mobile electronic device 15 that may be employed in the postage dispensing system 5. The mobile electronic device 15 includes a processor 35, an input apparatus 40, such as a keyboard, an output apparatus 45, such as an LCD display, and a memory 50. The processor 35 may be, for instance, and without limitation, a microprocessor (μP), and is responsive to inputs from the input apparatus 40 and provides output signals to the output apparatus 45. The processor 35 also interfaces with the memory 50. The memory 50 can be any of a variety of types of internal and/or external storage media such as, without limitation, RAM, ROM, EPROM(s), EEPROM(s), and the like that provide a storage register for data storage such as in the fashion of an internal storage area of a computer, and can be volatile memory or nonvolatile memory. The memory 50 additionally may include a number of routines executable by the processor 35 for implementing the invention as described herein and for the processing of data in accordance with the invention as described herein. The routines can be in any of a variety of forms such as, without limitation, software, firmware, and the like. The routines which implement the invention as described herein shall, for convenience, be referred to as the mobile electronic device postal application. As is known, the mobile electronic device postal application, if stored in the memory 50, may be provided thereto in a number of ways, such as, without limitation, by being downloaded from the provider data center 10 to the mobile electronic device 15 through the communication network 20, or by being transferred from a computer readable storage medium on which it is stored, such as a flash drive (e.g., a USB drive) or a compact disc, provided to a user of the mobile electronic device 15. Alternatively, the postal application may be a web service that is accessed by web pages using the mobile electronic device 15.

The mobile electronic device 15 also includes an electronic image capture device, preferably in the form of digital camera 55, for capturing digital images via an electronic image sensor, such as a charge coupled device (CCD) or a CMOS active-pixel sensor. The digital camera 55 is in electronic communication with the processor 35 for providing the captured digital images to the processor 35 for processing in accordance with the present invention. In the embodiment where the machine readable mechanism is an RFID tag, the mobile electronic device 15 also includes an RFID reading device 57 to enable reading of the information maintained in the RFID tag.

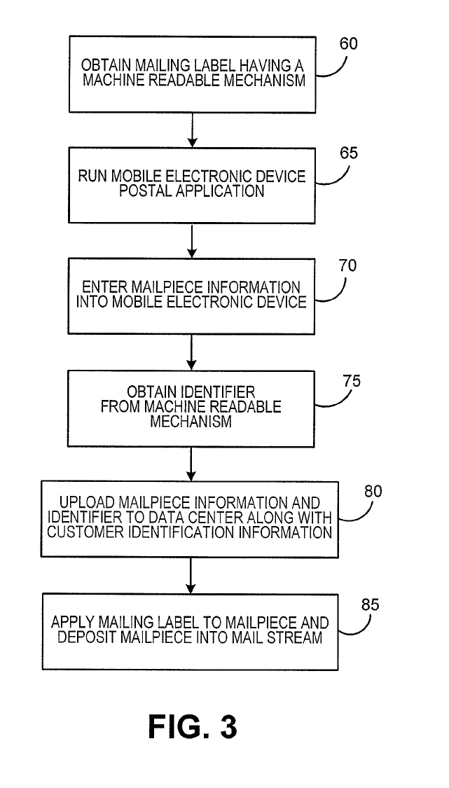

FIG. 3 is a flowchart showing a method of dispensing and providing postage using the postage dispensing system 5 according to one particular embodiment of the invention from the perspective of a user of a mobile electronic device 15 wishing to provide evidence of postage payment for a mailpiece. The method begins at steps 60, wherein the user of the mobile electronic device 15 obtains a mailing label having a machine readable mechanism 30, e.g., a pre-printed barcode or RFID tag. Next, at step 65, the user initiates the mobile electronic device postal application of the mobile electronic device 15 (or the postal application of a web service via web pages accessed by the mobile electronic device 15) and causes it to run. At step 70, the user then enters certain mailpiece information relating to the mailpiece to be mailed into the mobile electronic device 15 using the input apparatus 40. Such mailpiece information may include the type of mailpiece being mailed, e.g., letter or package, the amount of postage needed, the current date, the address of the recipient of the mailpiece, or any combination thereof. Alternatively, the amount of postage needed may be determined by the mobile electronic device postal application automatically from the mailpiece information entered thus far. The determined postage amount may then be included in the mailpiece information for the mailpiece. In one particular embodiment, the mobile electronic device 15 includes a GPS device for determining the current GPS coordinates of the mobile electronic device 15. Those coordinates, along with other mailpiece information such as the type of service desired (e.g., first class) and the recipient address, may be used by the mobile electronic device postal application to automatically determine the needed postage amount. In still another alternative embodiment, rather than manually entering the mailpiece recipient address information, the user may select that information from an address book application provided as part of the mobile electronic device 15, with the selected information being included in the mailpiece information.

Next, at step 75, the user obtains the identifier from the machine readable mechanism 30. In the case of a pre-printed barcode, the user captures a digital image of the pre-printed barcode obtained in step 60 using the digital camera 25. The captured image is saved in the memory 50. The mobile electronic device postal application then, using well known techniques, reads the pre-printed barcode 30 using the captured image thereof in order to obtain the barcode identifier provided therein. Alternatively, if the machine readable mechanism 30 is an RFID tag, the mobile electronic device is used to obtain the identifier provided therein using the RFID reading device 57. Then, at step 80, the mailpiece information entered and/or generated at step 70, and the barcode or RFID tag identifier obtained at step 75 are electronically uploaded to the provider data center 10 over the communication network 20. Also, unique customer identification information, such as a customer number assigned to the user by the provider, is uploaded to the provider data center 10 along with the mailpiece information and the barcode identifier so that the provider is able to determine the particular customer account that is associated with the current transaction. Then, at step 85, the user applies the mailing label containing the now “activated” machine readable mechanism 30, e.g., pre-printed barcode or RFID tag, to the mailpiece and places the mailpiece in the mail stream with the carrier.

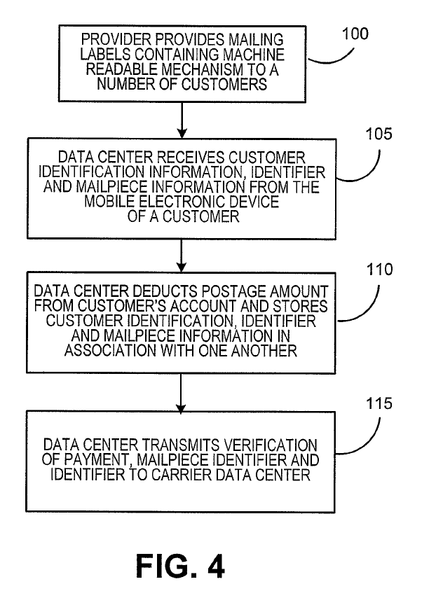

Referring to FIG. 4, a flowchart is provided that shows the method of the present invention from the perspective of the provider data center 10. The method begins at step 100, wherein the provider operating the data center 10 provides machine readable mechanisms 30, such as pre-printed barcodes (e.g., as part of labels or mailing devices) or RFID tags, to be available to a number of its customers. The provider data center 10 then, at step 105, receives customer identification information, a barcode or RFID tag identifier and mailpiece information (as described elsewhere herein) from the mobile electronic device 15 of a particular customer/user wishing to obtain evidence of postage payment through the communication network 20 (see step 85 of FIG. 3). Next, at step 110, the provider data center 10 deducts the postage amount indicated in the mailpiece information from the customer's account (using the customer identification information to determine the appropriate account) generates verification of payment information, which may be, for example, a simple acknowledgement of payment or digital signature obtained using the identifier and customer identification information, or any other type of unique information, and stores the verification of payment information, barcode (or RFID tag) identifier and mailpiece information in association with the customer identification information in a database operated by the provider data center 10. Finally, at step 115, the provider data center 10 transmits the verification of payment information, the amount of postage paid, and the barcode (or RFID tag) identifier to the carrier data center 25 through the communication network 20. In one particular embodiment, the provider data center 10 also transmits some or all of the mailpiece information (e.g., the recipient address information) to the carrier data center 25 through the communication network 20. The carrier data center 25 stores the received information for later use in validating payment for postage for the mailpiece in question (during mail audit procedures) and/or tracking the mailpiece in question when it enters the mail stream. Specifically, the barcode (or RFID tag) identifier can be read from a mailpiece by the carrier and the carrier data center 25 can check and verify that payment verification has been received for that barcode (or RFID tag) identifier. In addition, once verified, the carrier data center 25 can indicate in its memory that the specific barcode (or RFID tag) identifier has been used so that it or a copy thereof cannot later be fraudulently reused on a different mailpiece. Also, in the embodiment where the carrier data center 25 also receives recipient address information from the provider data center 10 in connection with the barcode identifier, in order to prevent fraud, the carrier can read the recipient address information from the mailpiece along with the barcode identifier and check to see whether the recipient address information that is read matches what is stored by the carrier data center 25 in association with the barcode identifier.

Thus, the present invention provides various embodiments of a system and method for dispensing and providing postage for a mailpiece that does not require a printer to be readily available to print evidence of postage payment. As a result, a user of a mobile electronic device that does not have ready access to a printer can easily obtain evidence of postage payment for a mailpiece as desired so that the mailpiece can be entered in the mail stream for delivery by a carrier.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of dispensing evidence of postage payment, comprising:
providing a machine readable mechanism for being associated with a mailpiece, said machine readable mechanism including a first identifier, said customer having a customer identifier;
receiving first information from a mobile electronic device associated with said customer, said first information including: (i) said first identifier, (ii) said customer identifier, and (iii) mailpiece information relating to said mailpiece, said first identifier included in said first information having been obtained from said machine readable mechanism captured by said mobile electronic device;
deducting a postage amount based on said mailpiece information from a postage account associated with said customer identifier; and
storing said first identifier in association with verification of payment for postage in a database.

2. The method according to claim 1, wherein said mailpiece information includes said postage amount.

3. The method according to claim 2, wherein said mailpiece information further includes recipient address information, wherein said transmitting further comprises transmitting said recipient address information to said carrier.

4. The method according to claim 1, wherein said machine readable mechanism comprises a barcode.

5. The method according to claim 4, wherein said barcode is provided on a label structured to be affixed to a mailing device of said mailpiece.

6. The method according to claim 4, wherein said barcode is pre-printed on a mailing device to be used with said mailpiece.

7. The method according to claim 4, wherein said barcode is a 2-D barcode.

8. The method according to claim 1, wherein said machine readable mechanism comprises an RFID tag.

9. A method of providing evidence of postage payment for a mailpiece, comprising:
obtaining a first identifier from a machine readable mechanism using a mobile electronic device associated with a customer, said customer having a customer identifier; and
transmitting first information from said mobile electronic device to a provider maintaining a postage account for said customer, said first information including: (i) said first identifier, (ii) said customer identifier, and (iii) mailpiece information relating to said mailpiece.

10. The method according to claim 9, wherein said mailpiece information includes a postage amount for said mailpiece.

11. The method according to claim 9, wherein said machine readable mechanism comprises a barcode, and obtaining a first identifier comprises:
capturing an image of the barcode and obtaining said first identifier from said image.

12. The method according to claim 11, wherein said barcode is provided on a label.

13. The method according to claim 11, wherein said barcode is pre-printed on a mailing device to be used with said mailpiece.

14. The method according to claim 11, wherein said barcode is a 2-D barcode.

15. The method according to claim 9, wherein the machine readable mechanism comprises an RFID tag.

16. The method according to claim 9, wherein said mailpiece information further includes recipient address information, wherein said transmitting further comprises transmitting said recipient address information to said provider.

17. A postal software application for a mobile electronic device, said mobile electronic device being associated with a customer having a customer identifier, said postal software application being stored on a computer readable medium and having a plurality of instructions for causing said mobile electronic device to:
obtain a first identifier from a machine readable mechanism; and
transmit first information from said mobile electronic device to a provider maintaining a postage account for said customer, said first information including: (i) said first identifier, (ii) said customer identifier, and (iii) mailpiece information relating to said mailpiece.

18. The postal software application according to claim 17, wherein said mailpiece information includes a postage amount for said mailpiece.

19. The postal software application according to claim 18, wherein said mailpiece information further includes recipient address information, wherein said instructions are adapted to cause mobile electronic device to transmit said recipient address information to said provider.

20. The postal software application according to claim 18, wherein said machine readable mechanism comprises a barcode.

21. The postal software application according to claim 18, wherein said machine readable mechanism comprises an RFID tag.
